(19) United States
(12) Patent Application Publication
(10) Pub. No.: US 2008/0217502 A1
(43) Pub. Date: Sep. 11, 2008

(54) Monolithic Framework Engine Mounting Structure

(75) Inventor: Laurent Lafont, Pechbusque (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Airbus France, Pechbusque (FR)

(21) Appl. No.: 12/066,916

(22) PCT Filed: Sep. 26, 2006
(86) PCT No.: PCT/EP2006/066731

§ 371 Date: Mar. 14, 2008

(30) Foreign Application Priority Data
Sep. 28, 2005 (FR) 05/52934

(51) Int. Cl. B64D 27/00; B21D 53/92

(52) U.S. Cl. 248/554; 29/897.2

(57) ABSTRACT

A structure for an aircraft engine assembly suspension pylori. The pylori includes a monolithic frame, manufactured for example by casting or welding, covered with mechanically assembled skins. Advantageously, stiffeners are mechanically fixed to points through which forces are applied. The dual structure makes it possible to take advantage of integration during manufacturing while respecting safety criteria due to mechanical assemblies.

### TECHNICAL FIELD

This invention relates in general to an aircraft engine suspension pylori. This type of suspension pylori is also called an EMS (Engine Mounting Structure), and can be used for example to suspend a turbojet below the aircraft wing, or to mount the turbojet above this wing through a plurality of attachments.

This invention more particularly concerns a new pylori structure and a method of manufacturing it.

### STATE OF PRIOR ART

In aircraft, a suspension pylori is designed to form the connection interface between an engine such as a turbojet and an aircraft wing. It transmits forces generated by its associated turbojet to the structure of the aircraft, and it also enables routing of fuel, electrical, hydraulic and air systems between the engine and the aircraft.

As shown in FIG. 1, an aircraft engine assembly 1 is designed to be fixed under a wing 2 of the aircraft, and comprises an engine such as a turbojet 3 and a suspension pylori 4. The turbojet 3 is provided with a large sized fan casing 5 at the forward end, delimiting an annular fan duct, and near the aft end comprises a smaller central casing 6 containing the core of this turbojet; the central casing 6 is prolonged in the aft direction by a larger sized exhaust casing 7; the casings 5, 6 and 7 are fixed to each other and extend along an axis AA.

The suspension pylori 4, a longitudinal element extending along a main direction parallel to the AA axis or slightly inclined from it, is particularly provided with a rigid structure carrying a plurality of engine suspensions 8 so as to fix the turbojet 3, and another series of suspensions (not shown) for suspension of this assembly 1 under the wing 2 of the aircraft.

For guidance, it should be noted that the assembly 1 is designed to be surrounded by a pod (not shown).

Throughout the description given below, the terms “forward” and “aft” should be considered with respect to a direction of movement of the aircraft that occurs as a result of the thrust applied by the turbojet 3, this direction being shown diagrammatically by the arrow 9.

In order to transmit forces, the pylori 4 normally comprises a rigid structure, often of the “box” type, in other words comprising edges composed of elements in the form of bars and connected by panels.

One conventional embodiment is shown in FIG. 2; a conventional suspension pylori thus comprises a rigid structure 10 in the form of a box formed from an upper spar 11 and a lower spar 12 both extending along a main direction similar to the direction of the AA axis of the engine 3. Two lateral panels 13 (only the aft panel can be seen in FIG. 2) are positioned on the sides of the stiffener 10 so as to “close” the pylori 4. The panels 13 usually comprise openings 14 to enable access to the different elements located in the pylori 4.

Transverse ribs 15 inside this box at a longitudinal spacing reinforce the stiffness of the structure 10; the ribs 15a resist forces, and the ribs 15b stabilise the structure 10 depending on their location.

Furthermore, the pylori 4 is provided with an assembly system 8 inserted between the turbojet 3 and the rigid structure 10; this system 8 comprises at least two engine suspensions, usually at least one forward suspension 16 and at least one aft suspension 17; furthermore, the mounting system 8 comprises a device for resisting thrusts generated by the turbojet 3, for example in the form of two lateral rods connected firstly to an aft part of the fan casing 5 of the turbojet 3, and secondly to an attachment point located between the forward suspension 16 and the aft suspension 17.

Similarly, the suspension pylori 4 also comprises a second mounting system 18 inserted between the rigid structure 10 and the aircraft wing 2, normally being composed of two or three suspensions.

Finally, the pylori is provided with a secondary structure for segregating and holding systems in place, while supporting aerodynamic fairings.

The main problem with this structure 10 is the difficulty in assembly; it is clear that the different ribs 15a, 15b must be fixed one by one to the spars 11, 12, and that their location is precisely determined, particularly due to the fixed location of the suspensions 16, 17 of the engine, optimised for its operation. Furthermore, the different attachment means increase the weight of the pylori 4, which is always a disadvantage in aeronautical applications.

### PRESENTATION OF THE INVENTION

The invention proposes a new structure for the suspension pylori of an aircraft, to simplify manufacturing and positioning of the pylori frame stiffeners while maintaining its safety-related properties.

According to one of its aspects, the invention thus proposes a method for assembling the suspension pylori structure in two steps combining different processes, namely:
monolithic manufacturing by welding, casting or any other process, of the pylori frame as such, in other words the edges and the ribs if any (and possibly one of the faces),
then mechanical attachment of the pylori closing panels.

The monolithic manufacturing method according to the invention can give an integral, unit frame, in other words that cannot be disassembled, although it can be manufactured from different elements in the case of welding.

Preferably, either before or after closing, stiffener fittings are also mechanically fixed at the most highly stressed locations.

There are many advantages in using two different techniques. In fact, integration of the frame can reduce the weight of this frame and its manufacturing time, by eliminating mechanical redundancies caused by the attachments. Furthermore, a mechanical attachment is kept such that the pylori as such is not “single piece”, a fragile structure compared with the use made of it; with a fully integrated structure, it is difficult to respect damage tolerance requirements of structures when this damage is caused by material, manufacturing or maintenance defects.

According to another aspect, the invention relates to an engine suspension pylori for an aircraft using the method according to the invention. The pylori thus comprises a monolithic structure, in other words a unit integrated structure including the edges of the box, and ribs if any, that is mechanically fixed to at least three of the four longitudinal panels extending along the principal direction of the pylori. The pylori advantageously comprises attachment points for the wing and the engine, each attachment point possibly being doubled up by a stiffener fitting mechanically fixed to the monolithic frame. In one particularly preferred manner, the panels may be made from a composite material and the frame may be made of metal, for example titanium.

### BRIEF DESCRIPTION OF THE DRAWINGS

The characteristics and advantages of the invention will be better understood after reading the following description with reference to the appended drawings, given for illustrative purposes and in no way limitative.

FIG. 1, already described, shows a lateral diagrammatic view of a partial aircraft engine assembly.

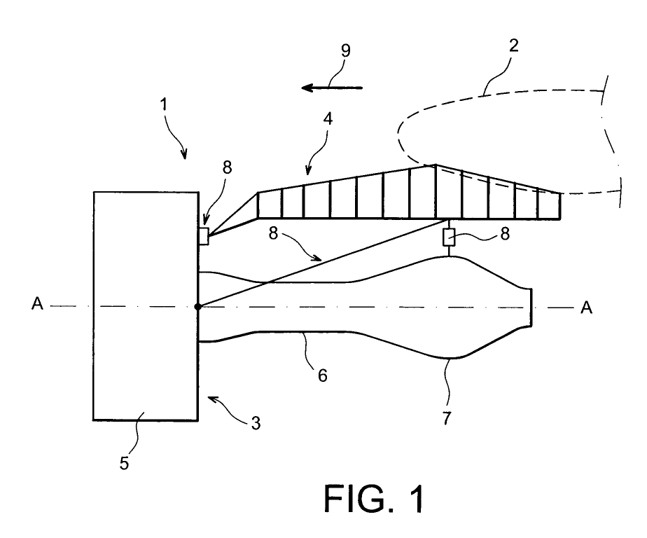

FIG. 2, already described, shows a suspension pylori according to the state of the art.

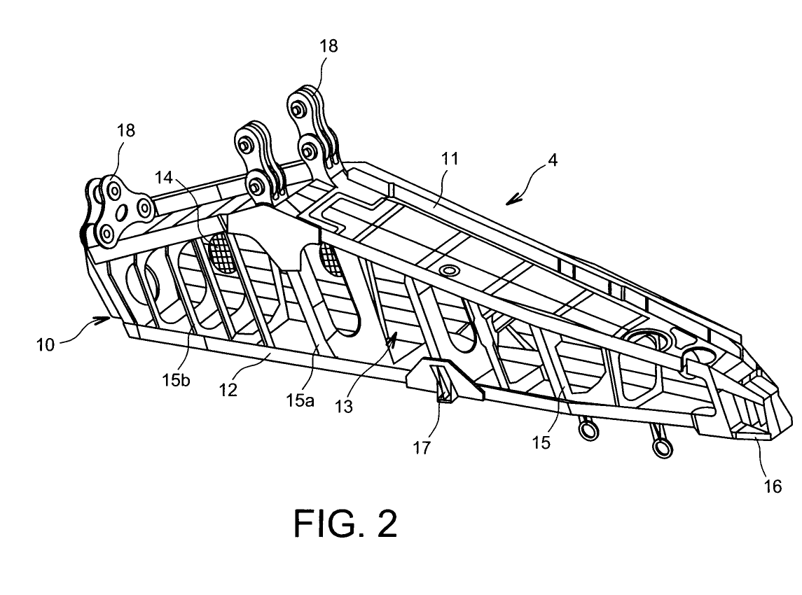

FIG. 3 shows a suspension pylori according to one preferred embodiment of this invention.

### DETAILED PRESENTATION OF PARTICULAR EMBODIMENTS

As described above, the manufacturing of suspension pylons is a long and complex process. However, there are few available solutions, considering the loads applied to the pylori and safety conditions respected in the aeronautical industry. The primordial function of the pylori in operation of the aircraft imposes strict reliability criteria, for example due to the intrinsic fail safe function for which a local failure must be compensated in all cases.

Thus, the invention proposes a pylori type for which the frame, but the frame alone, is of the monolithic and/or integrated type, to satisfy requirements while reducing the weight of the structure and simplify the manufacturing process. Complete integration of the pylori structure is not sufficient to satisfy the imposed conditions; for example if a crack appears on the material of a monolithic pylori, it can propagate to the remainder of the structure and create well-understood risks.

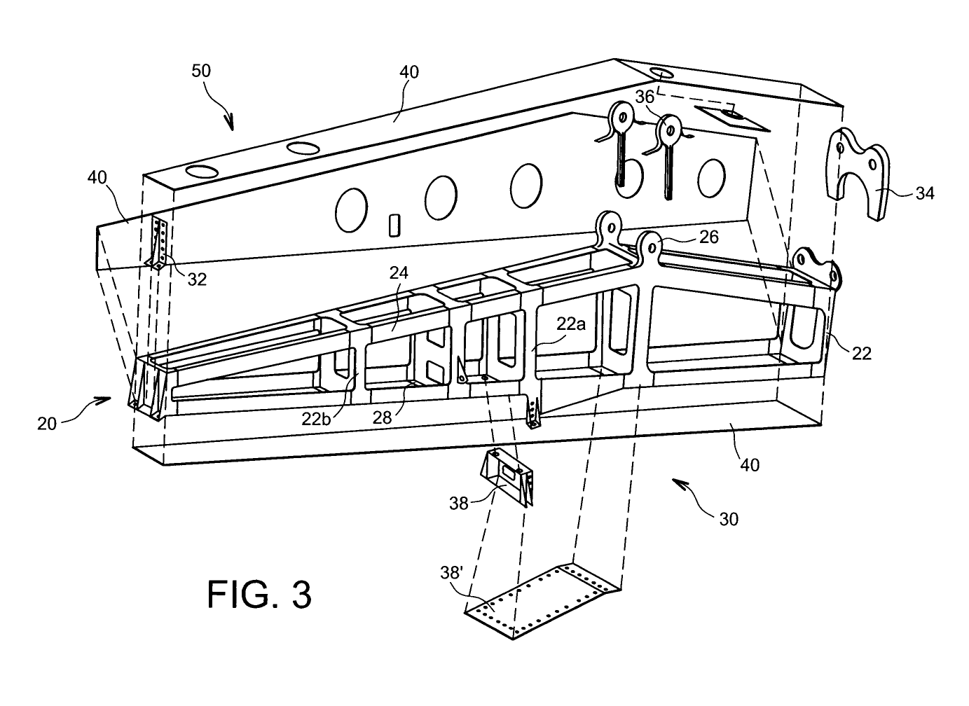

According to the invention and as shown in FIG. 3, the monolithic structure only applies to the frame 20, in other words the box “skeleton”; the ribs 22, the corner angles 24 (in other words the edges), the primary force input paths 26 (particularly the attachment points) are made in an integrated manner. The structure is then in the form of a frame 20 that defines a “box” with a predefined shape with four sides extending along a principal direction, by the addition of panels (currently referred to as the upper, lower, left side and right side panels) on the longitudinal faces and two end parts; the term “panel” as shown in FIG. 3 is not considered here as representing a structure in two dimensions; the upper panel thus has two quasi-plane parts forming an angle between them, which may or may not be unit. Possibly, according to the invention, only one of the longitudinal panels (particularly the lower panel), or a part of it, can be integrated into the frame 20.

According to one embodiment, the frame 20 may be formed by welding a large number of corner angles 24 on the different ribs 22, for example in the longitudinal direction; a first rib (also forming the end edges) is put into position, the first four corner angles (or longitudinal edges) are placed, and the rib 22 is then welded, followed by four second longitudinal edges, etc. The frame 20 thus made is finally in the form of a unit part that cannot be disassembled, for which the material is continuous. Therefore, with the structure according to the invention, the positioning of the force resistance ribs 22a is less restrictive considering that it is preferably possible to adapt the length of the corner angles 24.

By using a design adapted to the skeleton 20, the weld beads 28 are located in the skeleton periphery 20, so as to enable easy access to the weld heads and to tools for reworking the weld beads 28, for example by machining or grinding. With this preferred embodiment, the reliability of the welds can be increased due to burr removal that is now possible.

According to another embodiment, the frame 20 may for example be made by casting.

According to another embodiment, all elementary parts 22, 24 of the frame 20 are positioned on a mounting frame forming a future longitudinal face and are welded; this assembly can then be put in a furnace in which a so-called “relaxation” heat treatment is applied to it for a duration and at a temperature that depend on the material used, so as to relax the stresses generated by welding.

It should be noted that the graphic representation of the pylori is only given for guidance. In particular, the ribs 22 may be composed of frames that are not perpendicular to the principal direction of the pylori, but for example are oblique to it. The pylori may also have different geometries, for example such as varied fractions on the lower and/or upper faces (FIG. 3), different aerodynamic shapes of the left and/or right lateral faces. Finally, the shape of the pylori may be adapted depending on the method of resisting forces transmitted through the engine and wing suspensions. All these options are facilitated by the simplicity of the basic elements making up the frame 20.

Advantageously, fittings 30 are added to the skeleton thus formed, preferably by mechanical attachment, so as to double up the attachment points 26 for which forces are more critical. In particular for example, a forward engine suspension stiffener 32 may be screwed onto the frame, together with wing attachment stiffeners 34. Furthermore, the aft attachment point may be doubled up by an element 38 for forces introduced through the engine aft suspension, and by an element 38′ concerning the resistance of thrust forces; these two elements 38, 38′ may be also fixed to each other mechanically.

These fittings 30, which are fewer than in a conventional structure 10 and have a simpler shape, add a “fail safe” function in that damage to the structure of the frame 20 will be compensated by the fitting 30.

The frame 20 is then advantageously covered on its four longitudinal sides (or on the three remaining sides) by skin panels 40 fixed to it mechanically. Contrary to the prior art, in this case the panels perform a simple skin function, and may have low stiffness and can easily be made to match the shape dictated by the frame 20 during assembly. This quality can cause savings during manufacturing and use.

With the structure according to the invention, it is also possible to choose a different composition of the panels 40 with respect to the frame 20, and particularly to have a pylori 50 for which the frame 20 is made of steel, or titanium, the fittings 30 of special steel, and the panels 40 of a composite material; naturally, metallic panels 40 with the same nature as the remainder of the structure 20, 30 can be envisaged, together with any other steel, titanium, aluminium or composite alloy.

Thus, the invention is a compromise between an integration generating savings in the cost and weight, and a reduction in risks of breakage at junctions, and maximum safety criteria with a double “fail safe” structure. The pylori 50 according to the invention maintains all redundancies of known multi-part boxes with excellent damage tolerance, while enabling a significant saving due to the integration of primary force paths into the frame.

1-10. (canceled)

11. An engine suspension pylori for an aircraft, comprising:
a box type structure including an internal frame extending along a main direction, including four longitudinal panels forming a periphery of the structure along the main direction; and
attachment points configured for the engine and/or the wings,
wherein at least three of the longitudinal panels are mechanically fixed to the frame that defines edges of the box and that includes the attachment points, the frame being manufactured so as to be monolithic.

12. A suspension pylori according to claim 11, in which the monolithic frame further includes ribs at the attachment points of the pylori, composed of frames connecting the edges.

13. A suspension pylori according to claim 12, in which the monolithic frame further includes supporting ribs composed of frames connecting the edges.

14. A suspension pylori according to claim 11, in which the four longitudinal panels are mechanically fixed to the monolithic frame.

15. A suspension pylori according to claim 11, in which the frame is welded along the edges.

16. A suspension pylori according to claim 11, further comprising stiffener fittings mechanically fixed to the frame at the attachment points.

17. A suspension pylori according to claim 11, in which the frame is made from titanium and/or the panels are made from a composite material.

18. A process for manufacturing a box type aircraft engine suspension pylori comprising:
single piece manufacturing of the pylori frame; and
mechanical attachment of panels onto the frame.

19. A process according to claim 18, in which the single piece manufacturing is made by welding or by casting.

20. A process according to claim 18, further comprising mechanical attachment of stiffener fittings onto the frame.
